(19) United States
(12) Patent Application Publication
(10) Pub. No.: US 2009/0112645 A1
(43) Pub. Date: Apr. 30, 2009

(54) MULTI OBJECTIVE NATIONAL AIRSPACE COLLABORATIVE OPTIMIZATION

(75) Inventors: Pratik D. Jha, Herndon, VA (US); Rajesh Venkat Subbu, Clifton Park, NY (US); John Michael Lizzi, Wilton, NY (US); Naresh Iyer, Clifton Park, NY (US); Liviu Nedelescu, Bucharest (RO)

Correspondence Address: MARSH, FISCHMANN & BREYFOGLE LLP, 8055 East Tufts Avenue, Suite 450, Denver, CO, 80237, US

(73) Assignee: Lockheed Martin Corporation, Bethesda, MD (US)

(21) Appl. No.: 11/924,468

(22) Filed: Oct. 25, 2007

(51) Int. Cl. G06Q 10/00

(52) U.S. Cl. 705/7

(57) ABSTRACT

Systems and methods for planning and optimizing air traffic flow within an airspace are provided. In one embodiment, a system (200) includes: (1) a stakeholder objective evaluation module (212) receiving stakeholder preferences from stakeholders having an interest in flight routing within the airspace during an operational planning period and stakeholder metrics as feedback input and outputting strategic and flight route settings for the airspace based on the stakeholder preferences and stakeholder metrics; (2) a strategic optimization module (204) receiving the strategic settings, creating an initial airspace state, and generating an updated airspace state using the strategic settings; (3) a route optimization module (202) receiving the flight route settings and selecting preferred routes for flights during the operational planning period using the route settings; and (4) a simulation module (206) receiving simulation settings including the airspace state and the preferred routes, simulating flights during the operational planning period, and outputting the stakeholder metrics for feed-back.

### FIELD OF THE INVENTION

The present invention relates generally to air traffic control, and more particularly to collaborative planning and optimization of air traffic within an airspace involving multiple stakeholders.

### BACKGROUND OF THE INVENTION

The U.S. national Air Traffic Management (ATM) system is today operating at the edge of its capabilities, handling the real-time planning and coordination of over 50,000 flights per day. This situation will only worsen in the years to come, as it has been predicted that U.S. air traffic will nearly triple by the year 2025. There is a pressing need therefore for increasing capacity to meet future demand, improving safety, enhancing efficiency, providing additional flexibility to airline operators, and equitable consideration of multiple stakeholder needs in this complex dynamic system.

Current ATM concepts of operations and supporting automation systems have many limitations that constrain their capability for meeting future demand. These include rigid airspace and air routes that limit the level of air traffic that can be handled, poor utilization of available resources due to lack of collaboration among stakeholders, and limited system-level planning for the reconciliation of air traffic demand to available airspaces and airports.

Several proposals to modernize the ATM system have been put forward to accommodate the expected traffic growth. The Federal Aviation Administration (FAA) recently spurred a joint industry-government initiative—the Joint Program Development Office (JPDO). The JPDO was set up to coordinate the responsibility of charting the next generation ATM system, also known as the Next Generation Air Transportation System (NEXTGEN). The JPDO is currently developing operational concepts to address NEXTGEN requirements. The operational concepts aim to provide increased system capacity while ensuring that demand is met efficiently. Also, the aim is to provide greater flexibility and autonomy to the air service operators to manage their operations. They expect to allow operators to select the most fuel-efficient routes and update them under changing environmental and operational situations.

Traffic Flow Management (TFM) refers to the component of the ATM system that controls the distribution of resources and workload within the National Airspace System (NAS). At a strategic level, the Air Traffic Control System Command Center (ATCSCC) and Flights Operations Centers (FOCs) are charged with developing system-level plans. FOCs are responsible for developing individual flight plans and managing the overall operating schedule for the airlines. The ATCSCC in conjunction with other FAA entities must manage flows of aircraft to avoid overloading NAS resources such as airports, airspaces, waypoints, fixes etc. In cases where flow of traffic is affected by inclement weather or congestion, ATCSCC traffic managers must institute a flow control initiative to meet resource imbalance. Also, they must ensure that resource capacities are equitably distributed across competing airlines.

The flight planning process at an FOC typically starts at midnight, and aircraft dispatchers submit requests throughout the day. All scheduled carriers must submit a flight plan for each flight at least 45 minutes prior to departure. The ATCSCC receives these flight requests and approves the flight route based on the NAS situation. Flight plans submitted by the FOCs consider the effects of projected weather en route and advisories issued by the ATCSCC. However since FOC flight planning decisions are based on uncertain and forecast-based information, it is not unusual that in many cases once the flight plan is submitted, the ATCSCC may make modifications to the flight route during departure clearance or may impose traffic flow management restrictions that could lead to flight deviation while en route. This in most cases can drastically affect the airlines' schedule integrity and operating costs.

Under conditions where extreme disruptions are made to the NAS, operational decisions invoke the collaborative decision making process. In this process, FOCs representing participating airlines and traffic managers at the ATCSCC plan and make individual decisions that satisfy a common and understood set of goals and objectives.

Steadily increasing traffic densities have motivated the use of automation to alleviate controller workload and increase sector capacities. An “Automated Airspace” as a concept has been described, wherein automated flight separation command and control is proposed as a powerful means to decrease controller workload and thereby increase sector capacity. The role of aircraft-to-aircraft separation as a key traffic flow and congestion management control parameter has been highlighted.

Traffic controllers work at the level of sectors. The aggregate-level consisting of several sectors is called a center. Efficient forecasting of traffic flows and congestion at the center-level is important to anticipate and adapt to changing situations. Simulation-based (e.g. RAMS Plus gate to gate simulator developed by ISA Software) or model-based methods have therefore evolved to support this need.

Moderate to severe weather patterns have a principal effect on the efficiency of NAS operations. Rerouting around weather patterns may therefore be utilized as a principal traffic flow management strategy. Longer-term anticipatory rerouting allows a greater degree of planning freedom than shorter-term reactive tactical rerouting. Given that efficient anticipatory rerouting requires reliable weather forecasts, and given significant inherent uncertainties in the weather forecasts themselves, efforts have been invested to accommodate and manage forecast variance in traffic flow decision-making. Airspace configurations and traffic patterns have a principal effect on controller workload and efficiency. This relationship is known as “Airspace Complexity”. There is significant utility to modeling and representing this relationship for traffic flow planning, and efforts have been invested in this area. However, this relationship is complex, and planning tools that operate in this environment must be able to accommodate nonlinearities, continuous and discrete variables, and high-dimensional search. Therefore, stochastic optimization methods such as Evolutionary/Genetic Algorithms have been applied for planning and decision-support at multiple levels: at the sector configuration level; at the route and departure time planning levels; and at the airport ground operations level.

Evolutionary Algorithms (EAs) have received a lot of attention for use in optimization and learning applications, and have been applied to various practical problems. In recent years, the area of evolutionary multi-objective optimization has grown considerably, starting with the pioneering work of Schaffer.

Most real-world optimization problems have several, often conflicting objectives. Therefore, the optimum for a multi-objective problem is typically not a single solution—it is a set of solutions that trade-off between objectives. The Italian economist Vilfredo Pareto first generally formulated this concept in 1896, and it bears his name today. A solution is Pareto optimal if (for a maximization problem) no increase in any criterion can be made without a simultaneous decrease in any other criterion. The set of all Pareto optimal points is known as the Pareto frontier or alternatively as the efficient frontier. In the absence of further information, each such solution is as good as the others are when all objectives are jointly considered. Each solution on the Pareto frontier is not dominated by any other solution. Formally, given an n-dimensional measurable space whose elements can be partially ordered, a vector in this space x=(x₁, x₂, . . . , xₙ) is considered non-dominated if there exists no other vector z such that xᵢ≦zᵢ for all i, and xₖ<zₖ for at least one 1≦k≦n. The symbol ≦ may be interpreted as “the right-hand-side of it is as good as or better than its left-hand-side” without loss of generality.

Mathematical programming-based optimization methods for multi-objective problems generally require multiple executions to identify the Pareto frontier, and may in several cases be highly susceptible to the shape or continuity of the Pareto frontier, restricting their wide practical applicability. An evolutionary multi-objective optimizer works by systematically searching, memorizing, and improving populations of vectors (solutions), and performs multi-objective search via the evolution of populations of test solutions in an effort to attain the true Pareto frontier. This characteristic allows finding an entire set of Pareto optimal solutions in a single execution of the algorithm. Traditionally, multi-objective optimization has been pursued via the application of single-objective optimizers to linearly (or nonlinearly) weighted and aggregated objectives, and repeating the optimization for multiple weight combinations. While this traditional approach appears satisfactory in practice, the method is unable to identify non-convex regions of the Pareto frontier. This problem is more pronounced when the underlying models that represent mappings to multiple mutually competing output objectives are nonlinear.

Practical evolutionary search schemes do not guarantee convergence to the global optimum in a predetermined finite time, but they are often capable of finding very good and consistent approximate solutions. However, they are shown (theoretically and practically) to asymptotically converge under mild conditions.

### SUMMARY OF THE INVENTION

One consideration recognized by the present inventors is that to date, few efforts have concentrated on demonstrating the formulation of the complex planning and optimization problems underlying evaluation of air traffic within an airspace. The planning process has to ensure competing objectives of multiple stakeholders are addressed. Furthermore, since one is dealing with a system in which decisions are made over varying periods of time, there is the possibility of existence of time-based couplings, which if not suitably considered, could lead to substantial inefficiencies. These couplings need to be acknowledged, and their effects minimized to create an enterprise system with sustainable growth and scalability.

Accordingly, the system and method for planning and optimizing air traffic within an airspace provides a scalable enterprise framework for multi-stakeholder, multi-objective model-based planning and optimization of air traffic in the national airspace system (NAS). The approach is based on an intelligent evaluation and optimization of current state and future system demands. The evaluation not only considers local and system-level objectives, but also regards the impact of decisions on all stakeholders with the NAS. It is expected that this system will serve as a key decision-support tool to address future NAS scalability and reliability needs. Further, the system and method for planning and optimizing air traffic within an airspace provides a unique concept of operations for managing flows of aircraft and, more generally an applied methodology for automated planning and management of complex systems.

The next generation traffic flow planning (NEXTGEN) operational concept aims to pro-actively assist FOC operators in the management of air traffic flows such that the ATM capacity-demand imbalances are resolved. According to the concept, operators may be asked to map flight plans in 4 dimensions (henceforth referred to as 4-dimensional trajectories—4DTs) against an airspace resource database to assess mutual compatibility with the airspace capacity prior to submitting a flight plan. The mapping process will take into account weather uncertainties, status of special use airspaces, which may be reserved for exclusive military use, and other NAS-wide assets. The system may be continuously monitored to identify imbalances, and when they occur strategies may be developed to mitigate the problems. The operators may be encouraged by the FAA to play a more active and cooperative role in the mitigation process by asking them to adjust the flight plans in light of changed conditions. As more accurate NAS information can only be made available to the operators close to the departure time, operators may be given flexibility to file multiple 4DTs alternatives for a specific flight in order to adapt to changes. Also from the perspective of the FAA, the flow planning process may include managing conflicting objectives of multiple stakeholders competing for available resources.

The NEXTGEN operational concept may also provide operators with the flexibility and control to better manage their operations and at the same time ensure that ATM demands are met. To aid in the planning process, the operational concept proposes a central piece of automation called the “Evaluator”. The functionality of the Evaluator includes the ability to enable capacity prediction, demand prediction, and reconciliation of capacity-demand imbalances, while minimizing the effects of uncertainty, allowing for user flexibility, and minimizing human workload. The Evaluator operates on different operational time scales, from years through near-real time. One feature of the Evaluator is the traffic flow function, which operates roughly on a 24-hour time scale. Moreover, the use of a modular approach may be able to support tactical contingency management.

Automated NAS planning presents a number of challenges that are particularly demanding in the traffic flow domain. One challenge is weather and operational uncertainty in planning. The automated planning concept to a great degree relies on predicting demand, capacity, and their mutual imbalance. An assumption may be made regarding ability to forecast with confidence the weather and operational uncertainties. However, reality may be contrary to this assumption. A recent workshop report on weather forecasting accuracy for FAA traffic flow management by the National Research Council states that forecast for convective weather two to six hours in advance is non existent, and it's unlikely that the desired forecasting accuracy is achievable.

As with any planning process that involves time, this traffic flow planning process is a dynamic one. Because the traffic flow planning process plans for a future period, there is a need to make assumptions about the state of the system during that period, and if those assumptions do not materialize, there is a need to be able to adjust the assumptions. Therefore, an automated NAS planning function may include an adaptation mechanism to manage uncertainty.

Another challenge is planning computational complexity. Automated NAS planning requires a search over a large combinatorial space. Optimization has numerous search variables (degrees of freedom), some of which may be discrete and others continuous. In both these problems, the complexity of searching through the feasible space is significant. Adding further to the complexity is that there are typically no ultra fast evaluators (e.g. a regression equation or neural network) available to quickly evaluate the consequence of a given plan. In the interest of fidelity, one must rely on slower but accurate simulators to evaluate the consequence of a given strategy. The complexity in this planning problem space may therefore be considered a twofold problem of space and time. What is needed are powerful heuristics that can rapidly find good solutions with a minimal number of simulation executions.

Since, the NEXTGEN operational concept does not provide much detail on how the evaluator will be used for flow and flight planning, to guide the NAS planning formulation process a skeleton concept of operation has been developed. The concept of operation addresses the challenges that have been outlined herein. It should be noted that development of the concept of operation for the evaluator flow planning, and framework for planning and optimization co-evolved, and these may therefore be treated in a holistic manner.

The operational concept is built on providing airline operators NAS status information (for example expected congestion en route, expected arrival time etc.) so that they can integrate this information in their flight planning decisions. Based on airline business objectives the FOC may start planning using their in-house flight planning software at, for example, midnight. Once they have generated a flight path option for a particular flight they will submit it to the ATCSCC (potentially via a system wide information management-SWIM network) planning automation (Evaluator). The planning automation will evaluate the resource availability for that flight. In case en route congestion is predicted due to weather it will relay to the FOC the reason for the congestion and anticipated flight delay if they choose to fly that route. However, since the FOC planning is done significantly in advance, and the predictability of weather is low much in advance of departure, flexibility to manage uncertainty and meet FOC business objectives is desirable. Theoretically, an FOC can wait until the last minute to file the flight plan, but in practice an FOC has numerous flight plans to process, so they must continue to file flight plans in order to manage their workload. In case weather does not pose a problem the FOC should get the best possible route. In case weather does pose a problem the FOC should be able to settle for their second choice. So to respond to the inherent uncertainty, an FOC does the trial planning process iteratively and prepares a list of options that meets their goals. The FOC consequently files a flight plan that has multiple flight path options ranked in order of preference and with instructions for ATCSCC traffic managers as to which one should be selected given a particular weather or operational condition.

The traffic manager at the command center is responsible for flow planning and ensuring that NAS resources are equitably allocated. The traffic manager uses the congestion outlook from simulation to develop a strategic plan. If congestion is predicted for certain areas they can model the impact of different flow initiatives and choose the one that works best. Also traffic managers are responsible for choosing the best flight path option from a given set submitted by the FOCs. In order to do this at a regular time interval the traffic manager submits a list of flight plans to the evaluator. The evaluator considers the submitted flight plan in combination with other active and proposed flights, equity considerations, existing weather and operational condition for route assignments, and makes a best course recommendation.

The evaluator has a strategic layer for flow planning purposes that relies on model-based simulation techniques for forecasting congestion. The strategic layer guides the overall operations of the NAS. Running a fast-time simulation, which takes as input Official Airline Guide (OAG) data or historical flight plan data for flight schedules, route profiles, pre-coordinated restrictions, procedural changes and weather predictions, creates the initial NAS state. At preset time-intervals the simulation propagates the congestions and delays for the operational day. The refinements to the congestion predictions are made based on confirmation of flight paths, effectiveness of traffic flow initiatives and certainty of weather and operational outcomes.

The evaluator also has a route-planning layer that is used exclusively for ATCSCC. The route planning layer picks the best route for a flight given the prevailing condition and desired equitable distribution of resources. The equitable distribution of resources can be enforced by ranks. For example, an objective could be set to select a certain number of flight path options within each rank per airline operator. Another highlight of the flow planning function is that it eliminates the retrospective process of collaborative decision-making. It makes the planning more strategic as airline operators can now submit multiple flight preferences, and they can specify what to do to a particular flight in case a certain situation arises. The evaluator does not provide to the FOC any information that they could use for their benefit at the expense of other FOCs, and hence it prevents gaming in the system.

In one aspect, a system operable to plan and optimize air traffic flow within an airspace may include one or more of a stakeholder objective evaluation module, a strategic optimization module, a route optimization module, and a simulation module. In one embodiment, one or more of the stakeholder objective evaluation module, the strategic optimization module, the route optimization module, and the simulation module may be implemented in software executable by one or more computer processors, although one or more of the modules (or portions thereof) may be implemented in other manners including, for example hardware or programmable gate arrays.

The stakeholder objective evaluation module receives stakeholder preferences (e.g., 4 DT flight plans, airspace congestion considerations, allocation of airspace resources among aircraft operators, availability of reserved airspace) from one or more stakeholders having an interest in routing of flights within the airspace during an operational planning period and one or more stakeholder metrics as feedback input. The stakeholder objective evaluation module is operable to output strategic settings for the airspace and flight route settings for the airspace based on the stakeholder preferences and stakeholder metrics. The stakeholders may, for example, include one or more aircraft operators (e.g., commercial airlines, charter aircraft, corporate aircraft or private aircraft), one or more Air Navigational Service Providers (ANSPs) (e.g., the FAA the United States or other government/private agencies/entities having similar responsibilities in other countries), and one or more authorities responsible for reserving airspace for exclusive use (e.g., the Department of Defense in the United States or other government/private agencies/entities having similar responsibilities in other countries). The strategic optimization module receives the strategic settings and is operable to create an initial airspace state and generate an updated airspace state using the strategic settings. The route optimization module receives the flight route settings and is operable to select preferred routes for flights within the airspace during the operational planning period using the route settings. The simulation module receives simulation settings including the airspace state and the preferred routes. The simulation module is operable to simulate flights within the airspace during the operational planning period and output the stakeholder metrics that are fed-back to the stakeholder objective evaluation module.

In another aspect, a method for planning and optimizing air traffic flow within an airspace may include one or more of the following steps: (1) receiving stakeholder preferences (e.g., 4 DT flight plans, airspace congestion considerations, allocation of airspace resources among aircraft operators, availability of reserved airspace) from one or more stakeholders having an interest in routing of flights within the airspace during an operational planning period; (2) receiving one or more stakeholder metrics as feedback input; (3) generating strategic settings for the airspace and flight route settings for the airspace based on the stakeholder preferences and stakeholder metrics; (4) creating an initial airspace state using the strategic settings; (5) periodically updating the airspace state using the strategic settings during the operational planning period; (6) selecting preferred routes for flights within the airspace during the operational planning period using the flight route settings; and/or simulating flights within the airspace during the operational planning period to output the stakeholder metrics. The stakeholder preferences may be received from, for example, stakeholders such as one or more aircraft operators (e.g., commercial airlines, charter aircraft, corporate aircraft or private aircraft), one or more Air Navigational Service Providers (ANSPs) (e.g., the FAA the United States or other government/private agencies/entities having similar responsibilities in other countries), and one or more authorities responsible for reserving airspace for exclusive use (e.g., the Department of Defense in the United States or other government/private agencies/entities having similar responsibilities in other countries).

In one embodiment, the steps of receiving stakeholder preferences, receiving one or more stakeholder metrics as feedback input, and generating strategic settings for the airspace and flight route settings for the airspace may be performed using a stakeholder objective evaluation module, the steps of creating an initial airspace state and periodically updating the airspace state may be performed using a strategic optimization module that receives the strategic settings from the stakeholder objective evaluation module, the step of selecting preferred routes for flights within the airspace may be performed using a route optimization module that receives the route settings from the stakeholder objective evaluation module, and the step of simulating flights within the airspace may be performed using a simulation module that receives simulation settings including the airspace state from the strategic optimization module and the preferred routes from the route optimization module. In this regard, one or more of the stakeholder objective evaluation module, the strategic optimization module, the route optimization module, and the simulation module may be implemented in software executable by one or more computer processors, although one or more of the modules (or portions thereof) may be implemented in other manners including, for example hardware or programmable gate arrays.

These and other aspects and advantages of the present invention will be apparent upon review of the following Detailed Description when taken in conjunction with the accompanying figures.

### DESCRIPTION OF THE DRAWINGS

FIG. 1 is a schematic overview of one embodiment of a NAS multi-level evaluator/optimizer architecture;

FIG. 2 is a schematic representation of one embodiment of a NAS multi-level planner/optimizer framework;

FIG. 3 shows an exemplary NAS planning segmented timeline;

FIG. 4 shows an exemplary NAS planning segmented timeline iteration;

FIG. 5A-5D show exemplary plots of notional interrelationships between planning time variables and planning characteristics; and

FIG. 6 is a flow chart showing one embodiment of a method for planning and optimizing air traffic flow within an airspace.

### DETAILED DESCRIPTION

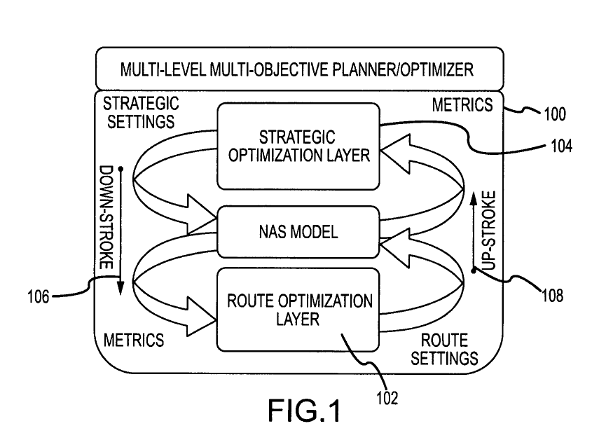

FIG. 1 schematically represents one embodiment of a national airspace system (NAS) multi-level evaluator/optimizer architecture 100. The multi-level evaluator/optimizer architecture 100 may be decomposed hierarchically into two layers: the Route Optimization Layer (ROL) 102 and the Strategic Optimization layer (SOL) 104. The ROL 102 optimizes multiple system and stakeholder objectives based on one or more flight path requests. Route optimization may be performed each time a flight path request is made or at a pre-defined frequency corresponding to a planning horizon. During route optimization, the strategic policy-level state of the system will be kept fixed, constituting a down-stroke optimization as represented by arrow 106. The SOL 104 optimizes multiple system and stakeholder objectives based upon strategic traffic flow parameter settings. During strategic optimization, an instantiation of optimized routes is assumed and held fixed, constituting an up-stroke optimization as represented by arrow 108. The SOL 104 develops optimal strategies to handle a given flight demand, weather phenomenon, airspace configuration, and other input considerations. Strategic optimization is performed less frequently than route optimization.

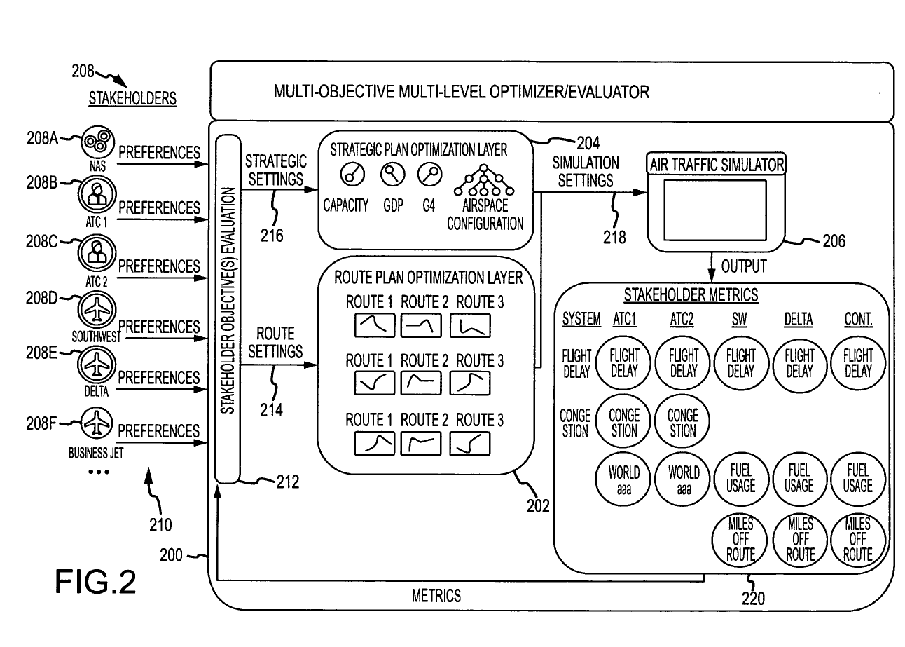

FIG. 2 expands on the multi-level planner/evaluator/optimizer architecture 100 shown in FIG. 1 and presents one embodiment of a scalable enterprise framework 200 for planning and optimization of an air traffic control system using simulation-based (or model-based) optimization. The multi-objective multi-level planner/optimizer framework 200 incorporates the route optimization layer (ROL) 202, the strategic optimization layer (SOL) 204, and a high-fidelity airspace and air traffic simulator 206. The ROL 202, the SOL 204, and the high-fidelity airspace and air traffic simulator 206 may also be referred to herein as a route optimization module 202, the strategic optimization module 204, and the simulation module 206, respectively.

The simulation module 206 is utilized to enable both the strategic-level and route-level optimizations. The strategic optimization is a mixed optimization problem, in that there could be discrete variables (such as collaboration policy settings and airspace configurations) and continuous variables (such as airspace demand). The route-level optimization is principally a combinatorial optimization problem, in that the goal is determining the best portfolio of a combination of flight path requests, one for each flight, within a certain planning horizon.

The multi-objective multi-level planner/optimizer framework 200 considers multi-objective needs of stakeholders 208 at various levels of the airspace demand and control process. Exemplary stakeholders 208 include an NAS 208A, one or more ATCSCCs 208B, 208C, one or more commercial airline operators 208D, 208E, and one or more business jet operators 208F. Stakeholder-driven preference functions 210 are utilized in a stakeholder objective(s) evaluation module 212 wherein the “goodness” of a given solution is evaluated. The stakeholder objective(s) evaluation module 212 results in route settings 214 and strategic settings 216, with the route settings 214 being applied in the ROL 202 and the strategic settings 216 being applied in the SOL 204.

The ROL 202 and SOL 204 utilize advanced simulation-based (RAMS Plus airspace simulator) airspace criteria evaluation during planning and optimization. The planning and optimization is based on advanced heuristics, and genetic algorithms. The multi-objective decision-making is based on the use of preference functions and Pareto-based alternatives selection.

The ROL 202 and SOL 204 result in simulation settings 218 that are provided to the simulator 206. The simulator 206 in turn outputs stakeholder metrics 220 that are fed-back to the stakeholder objective(s) evaluation module 212.

An airspace may be considered to be a three-dimensional (specified by latitude, longitude, and altitude) compact volumes. Operating flights may intersect with the airspace at any given time. An intersection of a flight with an airspace may be due to takeoff, landing, or en route activities. One goal in the NAS is facilitation of congestion-free safe flights across airspaces while respecting multiple stakeholder preferences. However, during a typical day, weather-related and operational uncertainties may creep in and complicate the planning process and flight path task execution. It is therefore highly advantageous to not only perform flight path planning with as reliable a forecast of weather and operational issues as is feasible, but also to consider the effect over a longer-term time horizon of a particular flight plan in combination with flights within the purview of a given airspace. Such a longer-term behavioral projection may be achieved by simulating airspace activity as a function of time using a reliable airspace simulation tool.

In simulation-based planning and decision-making, there is significant benefit to a just-in-time mode of planning, when forecasts for the immediate future are most reliable. However, simulation of any airspace with significant flight activity is a computationally challenging task requiring one to plan in advance rather than just-in-time. Moreover, as planning will also have to consider the longer-term effect of a decision, certainty decays, influencing the quality of the decisions made.

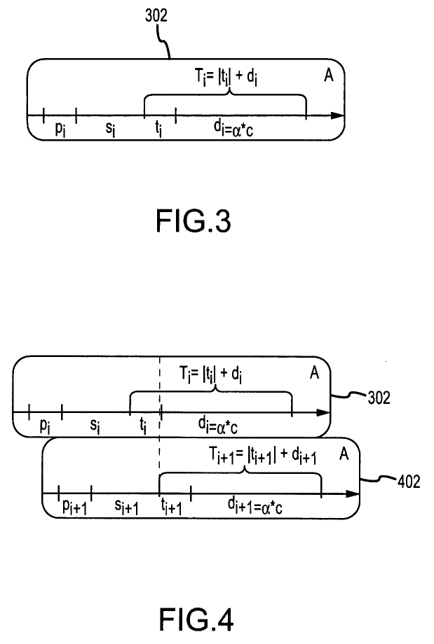

FIG. 3 shows a segmented NAS planning timeline 302 (represented by vector A) for the planning iteration at time block i. The flight path-planning problem may be first considered in the route optimization layer, such as route optimization layer 102, 202 of FIG. 1 or 2. In the timeline 302, c represents the time duration for an average flight in the NAS, α represents a scaling coefficient, Fᵢ^{t} is the set of flights that take off during time window tᵢ, pᵢ is the time window available to perform simulation-based planning for flights Fᵢ^{t}. It may be assumed that |pᵢ|<|tᵢ|, so planning will never fall behind as time progresses. Tᵢ is the longer-term time window to be simulated during planning for flights Fᵢ^{t}. In order to evaluate the expected behavior of flights Fᵢ^{t}, they will need to be considered in combination with other active flights during time window dᵢ=α*c. In FIG. 3, sᵢ represents the time difference between the planning window and the take off window. A non-zero sᵢ is necessary to perform any look-ahead planning.

During route planning for flights Fᵢ^{t} at time pᵢ, an assumption is made regarding the flight paths for flights Fᵢ^{d} that take off during time window dᵢ. Without this key assumption, the problem will extend to one of joint planning of all the flights during an operational day in the NAS, which is not a desired goal either from the perspective of problem complexity or from the perspective of uncertainty that frequently affects the quality of solutions optimized significantly prior to a departure event. Therefore, the most likely or default routes for flights Fᵢ^{d} may be assumed during this planning.

FIG. 4 shows the segmented NAS planning timeline 402 (represented by vector A) for the planning iteration at the next time block i+1. During this time, the optimized paths for flights Fᵢ^{t} are used as prior state information. It may be expected that many of these flights from the set Fᵢ^{t} will be active for the duration dᵢ₊₁.

The segmented planning timelines 302, 402 at times i and i+1 shown respectively in FIGS. 3 and 4 are useful in understanding the strategic planning problem in the SOL 104 or 204 of FIG. 1 and FIG. 2. One significant difference of strategic planning with respect to the above discussion on route planning is that strategic planning occurs at a much lower frequency. It is therefore reasonable to assume that strategic policy settings made during planning window pᵢ will hold for the time duration represented by Tᵢ, and continue until the next strategic planning trigger. However, when such a trigger occurs (e.g., during some planning window pⱼ₊₁), it should be noted that the strategic policy changes will not take effect until such time that the duration dⱼ ends. This non-overlapping nature of the time periods associated with the strategic plans may be enforced so as to not invalidate the environmental behavioral assumptions made at the strategic level during earlier route-level planning.

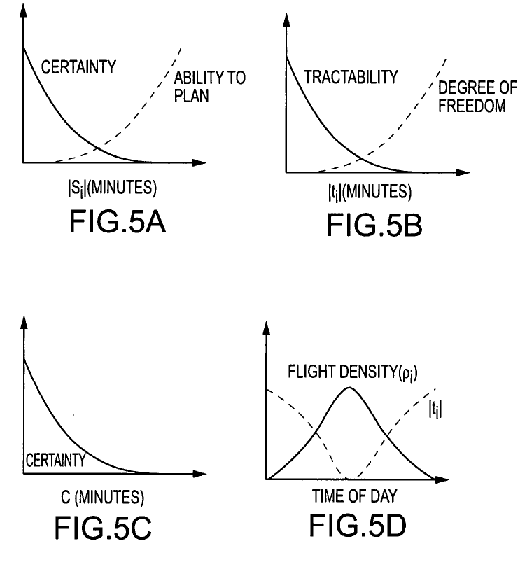

FIGS. 5A-5D are plots showing notional relationships or tradeoffs between various planning time variables (e.g., the time difference sᵢ between the planning window and the take off window, the time window tᵢ during which the set of flights take off, the time duration c for an average flight in the NAS, and the time of day) and factors such as computational tractability, certainty, ability to plan, degree of freedom, and flight density ρᵢ.

Specifically, as shown in FIG. 5A, when the magnitude of the look-ahead planning window sᵢ increases, forecast certainty reduces, but the ability to do advance planning increases. As shown in FIG. 5B, when the magnitude of the take-off planning window tᵢ increases, the number of flights for which joint planning needs to be performed increases, reducing the tractability of the planning problem. However, when the magnitude of the take-off window tᵢ increases, the degree of freedom (“levers available”) of the planning function increases, increasing the chance to affect system inertia. As shown in FIG. 5C, when the duration of the average flight c in the NAS increases, forecast certainty decreases, influencing the quality of the planned solutions. These above interrelationships indicate that there are intersecting tradeoff points respectively between certainty and ability to plan; and computational tractability and degree of freedom. These intersecting points may shed light on the selection of the magnitudes of time variables sᵢ and tᵢ. Additionally, these tradeoff points may move as the nature of the airspace system and associated technologies mature.

A new optimization problem is introduced to determine planning variable settings (sᵢ, tᵢ) to maximize the ability to plan while reducing uncertainty and maximizing system optimality. As shown in FIG. 5D, throughout a given operational time period, the density ρᵢ of flight activity in the NAS will change. Changes in this density logically correlate to the number of flights taking off during any tᵢ. Due to the aforementioned combinatorial and computational constraints, tᵢ must therefore be dynamically adjusted based upon flight density ρᵢ at time i. As shown in FIG. 5D, as flight density ρᵢ increases the magnitude of tᵢ must decrease to work within the bounds of given computational constraints.

In the following discussion of planning and system stability, reference is made to the time iteration i+1 in FIG. 4, and the complete set of flights during an operational period in the NAS is identified as set F. It may be assumed for convenience that operational activity starts with time block to, and planning for that time block is done earlier at p₀. During this first planning block, flights F₀^{t} are planned. Default (most likely) routes for flights F₀^{d} are assumed. This assumption is the same as picking default flight options for all flights in the set difference F−F₀^{t}. In the next planning block p₁, for time block t₁, flights F₁^{t} are planned. In this planning block, default flight path options are picked for all flights in the set difference F−(F₀^{t}+F₁^{t}, where + signifies the set union operation, and − signifies the set difference operation.

An observation is that |F−F₀^{t}|>|F−(F₀^{t}+F₁^{t})|, implying that the number of overall flights for which there is a need to pick a default path option will be smaller in a future planning instance than at the current instance. In general, |F−(F₀^{t}+F₁^{t})|> . . . >|F−(F₀^{t}+F₁^{t}+ . . . Fₙ^{t})|, implying that as time progresses towards a long-term planning horizon, the number of overall flights for which one picks the default path option will systematically reduce. The same reasoning may be applied under the assumption that F is set of flights spanning some reasonable number of operational days.

It may be noted that a default flight path assumed as a future system state is more likely to be changed later due to operational and weather related uncertainties. Since earlier flight planning is performed with default assumptions regarding the future, a change in a future state would potentially increase the entropy of the system.

The lesser the number of default assumptions that later change, the lesser the entropy of the system. Under this reasoning, it is reasonable to expect that as time progresses, the entropy of the optimized NAS would decrease. However, there is also the potential that flight paths planned and previously deployed are tactically changed en route due to changes in the operational environment and weather. Such changes will increase the entropy of the optimized NAS as well. Regardless, it may be expected that planning performed with forecasts as reliable as possible will minimize this potential. This is essentially the principal benefit of iterative optimization with reliable forecasting.

An advantage of distribution of computation in a simulation-based optimization framework is the potential for linear (or possibly even super-linear) speedups when a fast intercommunications bus or network is utilized. A key step is therefore problem decomposition, or partitioning of the airspace A into simulation chunks corresponding to airspaces {A¹, A², . . . A^{a}} such that degree of flight interaction or coupling between any two airspace chunks is the minimum possible. If there is a strong coupling between two airspace chunks, then coordinating the simulations between these two chunks will incur a higher communications overhead. Regardless, decentralizing the computation will have significant payback compared to the centralized model via reduction in the simulation-based computational complexity associated with each of the computational chunks.

One insight in decentralized (or collaborative) planning is the need for a time-synchronous computation between coupled airspaces so the simulation is consistent with the overall centralized computation model. Since flight handoffs will occur between coupled airspace simulations, it is important that that all the computational entities in this decentralized planning framework logically compute at the same rate, even if the actual computational speeds may be dissimilar. The communication between coupled airspace simulations may occur at the most coarse time granule that supports required fidelity. In this regard, it might be a significant waste of computational resources for airspace simulations to communicate flight paths and intents very often (e.g., every second), while communication less often (e.g., once every five minutes) may be sufficient to ensure fidelity and reduce the communications overhead.

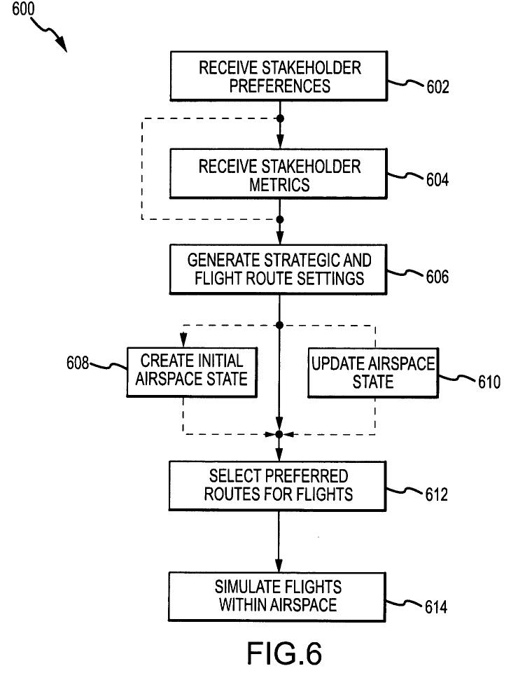

FIG. 6 shows the steps involved in one embodiment of a method 600 for planning and optimizing air traffic flow within an airspace throughout the duration of an operational planning period. In this regard, the method 600 may, for example, be conducted to plan and optimize air traffic flow for an operational planning period that commences at a specified start time during the day (e.g. at 12 a.m.) and extends for a predetermined time period (e.g., 24 hours) from the specified start time. The steps of the method 600 may be conducted in an iterative fashion (e.g., for time i, i+1, i+2, etc. where time i is specified in, for example, seconds, minutes, or some other desired time measure) until air traffic flow within the airspace is planned and optimized for the entirety, or some desired portion, of the operational planning period.

In step 602 of the method 600, stakeholder preferences are received from one or more stakeholders having an interest in routing of flights within the airspace during an operational planning period. In step 602, stakeholder preferences may, for example, be received from stakeholders such as, for example, an NAS, one or more ATCSCCs, one or more aircraft operators (e.g., commercial airline operators, business jet operators, and/or private plane operators). Examples of stakeholder preferences that may be received in step 602 include airspace congestion considerations and considerations relating to equitable allocation of airspace resources among aircraft operators from, for example, the ATCSSC(s) and flight plan requests from the aircraft operator(s).

In step 604, one or more stakeholder metrics are received as feedback input. Stakeholder metrics received as feedback input in step 604 may, for example, include information relating to flight departure delays, flight arrival delays, congestion within the airspace, fuel usage by aircraft, and mileage off route from requested flight routes. During the first iteration of the method 600, there may be no stakeholder metrics received as feedback input in step 604 as such stakeholder metrics may not be generated by the method 600 until the first iteration is completed.

In step 606, strategic settings for the airspace and flight route settings for the airspace are generated based on the stakeholder preferences and stakeholder metrics. In step 608, an initial airspace state is created using the strategic settings. The strategic settings that are used in step 608 in creating the initial airspace state may include, for example, OAG data for flight schedules or historical flight data, route profiles, pre-coordinated restrictions, procedural changes, and weather predictions. In conducting the method, creation of the initial airspace state in step 608 may be done only during the first iteration of the method 600 and thereafter step 608 may be skipped.

In step 610, the airspace state is periodically updated using the strategic settings during the operational planning period. The strategic settings that are used in step 610 in periodically updating the airspace state may include, for example, information confirming flight paths within the airspace, information relating to air traffic flow within the airspace, and information relating to certainty of weather outcomes.

In step 612, preferred routes for flights within the airspace during the operational planning period are selected using the flight route settings. In conducting the method 600, step 612 wherein preferred routes are selected may be performed more frequently than step 610 wherein the airspace state is updated. For example, step 612 may be performed every iteration, whereas step 610 may only be performed on an as needed basis.

In step 614, flights within the airspace during the operational planning period are simulated to output the stakeholder metrics. The stakeholder metrics output in step 614 for a particular iteration of the method are received as the feedback input in step 604 during the next iteration.

While various embodiments of the present invention have been described in detail, further modifications and adaptations of the invention may occur to those skilled in the art. However, it is to be expressly understood that such modifications and adaptations are within the spirit and scope of the present invention.

What is claimed is:

1. A system operable to plan and optimize air traffic flow within an airspace, said system comprising:
a stakeholder objective evaluation module receiving stakeholder preferences from one or more stakeholders having an interest in routing of flights within the airspace during an operational planning period and one or more stakeholder metrics as feedback input, said stakeholder objective evaluation module being operable to output strategic settings for the airspace and flight route settings for the airspace based on the stakeholder preferences and stakeholder metrics;
a strategic optimization module receiving the strategic settings, said strategic optimization module being operable to create an initial airspace state and generate an updated airspace state using the strategic settings;
a route optimization module receiving the flight route settings, said route optimization module being operable to select preferred routes for flights within the airspace during the operational planning period using the route settings; and
a simulation module that receives simulation settings including the airspace state and the preferred routes, said simulation module being operable to simulate flights within the airspace during the operational planning period and output the stakeholder metrics, the stakeholder metrics being fed-back to the stakeholder objective evaluation module.

2. The system of claim 1 wherein the stakeholders include at least one ANSP and at least one aircraft operator, and wherein the stakeholder preferences include airspace congestion considerations and considerations relating to equitable allocation of airspace resources among aircraft operators from the at least one ANSP and flight plan requests including 4DT flight plans from the at least one aircraft operator.

3. The system of claim 2 wherein the stakeholders further include at least one authority responsible for reserving airspace for exclusive use and wherein the stakeholder preferences further include information regarding availability of reserved airspace from said at least one authority.

4. The system of claim 1 wherein the strategic settings used by the strategic optimization module in creating the initial airspace state include OAG data for flight schedules, route profiles, pre-coordinated restrictions, procedural changes, and weather predictions.

5. The system of claim 1 wherein the strategic settings used by the strategic optimization module in updating the airspace state include information confirming flight paths within the airspace, information relating to air traffic flow within the airspace, and information relating to a certainty of weather outcomes.

6. The system of claim 1 wherein the stakeholder metrics include information relating to flight departure delays, flight arrival delays, congestion within the airspace, fuel usage by aircraft, a mileage off route from requested flight routes.

7. The system of claim 1 wherein the operational planning period begins at a specified start time during a day and extends for a predetermined time period from the specified start time.

8. The system of claim 7 wherein the specified start time is 12 a.m. and the predetermined time period is 24 hours.

9. The system of claim 1 wherein strategic optimization module updates the airspace state less frequently than the route optimization module selects preferred routes for flights within the airspace during the operational planning period.

10. The system of claim 1 wherein one or more of said stakeholder objective evaluation module, said strategic optimization module, said route optimization module, and said simulation module are implemented in software executable by one or more computer processors.

11. A method for planning and optimizing air traffic flow within an airspace, said method comprising the steps of:
receiving stakeholder preferences from one or more stakeholders having an interest in routing of flights within the airspace during an operational planning period;
receiving one or more stakeholder metrics as feedback input;
generating strategic settings for the airspace and flight route settings for the airspace based on the stakeholder preferences and stakeholder metrics;
creating an initial airspace state using the strategic settings;
periodically updating the airspace state using the strategic settings during the operational planning period;
selecting preferred routes for flights within the airspace during the operational planning period using the flight route settings; and
simulating flights within the airspace during the operational planning period to output the stakeholder metrics.

12. The method of claim 11 wherein said step of receiving stakeholder preferences comprises:
receiving airspace congestion considerations and considerations relating to equitable allocation of airspace resources among aircraft operators from the at least one ANSP; and
receiving flight plan requests including 4DT flight plans from the at least one aircraft operator.

13. The method of claim 12 wherein said step of receiving stakeholder preferences further comprises:
receiving information regarding availability of reserved airspace from at least one authority responsible for reserving airspace for exclusive use.

14. The method of claim 11 wherein said step of creating an initial airspace state comprises using strategic settings that include OAG data for flight schedules, route profiles, pre-coordinated restrictions, procedural changes, and weather predictions.

15. The method of claim 11 wherein said step of periodically updating the airspace state comprises using strategic settings that include information confirming flight paths within the airspace, information relating to air traffic flow within the airspace, and information relating to a certainty of weather outcomes.

16. The method of claim 11 wherein said step of receiving one or more stakeholder metrics as feedback input comprises receiving stakeholder metrics that include information relating to flight departure delays, flight arrival delays, congestion within the airspace, fuel usage by aircraft, and mileage off route from requested flight routes.

17. The method of claim 11 wherein the operational planning period begins at a specified start time during a day and extends for a predetermined time period from the specified start time.

18. The method of claim 17 wherein the specified start time is 12 a.m. and the predetermined time period is 24 hours.

19. The method of claim 11 wherein said step of periodically updating the airspace state is performed less frequently during the operational planning period than said step of selecting preferred routes.

20. The method of claim 11 further comprising:
using a stakeholder objective evaluation module to perform said steps of receiving stakeholder preferences, receiving one or more stakeholder metrics as feedback input, and generating strategic settings for the airspace and flight route settings for the airspace;
using a strategic optimization module that receives the strategic settings from the stakeholder objective evaluation module to perform said steps of creating an initial airspace state and periodically updating the airspace state;
using a route optimization module that receives the route settings from the stakeholder objective evaluation module to perform said step of selecting preferred routes for flights within the airspace; and
using a simulation module that receives simulation settings including the airspace state from the strategic optimization module and the preferred routes from the route optimization module to perform said step of simulating flights within the airspace;
wherein one or more of the stakeholder objective evaluation module, the strategic optimization module, the route optimization module, and the simulation module are implemented in software executable by one or more computer processors.

21. A system for planning and optimizing air traffic flow within an airspace, said system comprising:
means for receiving stakeholder preferences from one or more stakeholders having an interest in routing of flights within the airspace during an operational planning period;
means for receiving one or more stakeholder metrics as feedback input;
means for generating strategic settings for the airspace and flight route settings for the airspace based on the stakeholder preferences and stakeholder metrics;
means for creating an initial airspace state using the strategic settings;
means for periodically updating the airspace state using the strategic settings during the operational planning period;
means for selecting preferred routes for flights within the airspace during the operational planning period using the flight route settings; and
means for simulating flights within the airspace during the operational planning period to output the stakeholder metrics.

22. The system of claim 21 wherein said means for receiving stakeholder preferences receive airspace congestion considerations and considerations relating to equitable allocation of airspace resources among aircraft operators from at least one ANSP, receive flight plan requests including 4DT flight plans from at least one aircraft operator, and receive information regarding availability of reserved airspace from at least one authority responsible for reserving airspace for exclusive use.

23. The system of claim 21 wherein said means for creating an initial airspace state use strategic settings that include OAG data for flight schedules, route profiles, pre-coordinated restrictions, procedural changes, and weather predictions, wherein said means for periodically updating the airspace state use strategic settings that include information confirming flight paths within the airspace, information relating to air traffic flow within the airspace, and information relating to a certainty of weather outcomes, and wherein said means for receiving one or more stakeholder metrics as feedback input receive stakeholder metrics that include information relating to flight departure delays, flight arrival delays, congestion within the airspace, fuel usage by aircraft, a mileage off route from requested flight routes.

24. The system of claim 21 wherein said means for periodically updating the airspace state periodically update the airspace state less frequently during the operational planning period than said means for selecting preferred routes selects preferred routes.

25. The system of claim 21 wherein:
said means for receiving stakeholder preferences, said means for receiving one or more stakeholder metrics as feedback input, and said means for generating strategic settings for the airspace and flight route settings for the airspace comprise a stakeholder objective evaluation module;
said means for creating an initial airspace state and said means for periodically updating the airspace state comprise a strategic optimization module that receives the strategic settings from the stakeholder objective evaluation module;
said means for selecting preferred routes for flights within the airspace comprise a route optimization module that receives the route settings from the stakeholder objective evaluation module;
said means for simulating flights within the airspace comprise a simulation module that receives simulation settings including the airspace state from the strategic optimization module and the preferred routes from the route optimization module; and
one or more of the stakeholder objective evaluation module, the strategic optimization module, the route optimization module, and the simulation module are implemented in software executable by one or more computer processors.
